(19) United States
(12) Patent Application Publication
(10) Pub. No.: US 2011/0153626 A1
(43) Pub. Date: Jun. 23, 2011

(54) DEVICE AND METHOD FOR PERFORMING MAPPING OF DATA OF NETWORK DEVICE

(75) Inventors: Young-Sung SON, Daejeon (KR); Ji-Yeon Son, Daejeon (KR); Hark-Jin Lee, Gumi-si (KR); Kyeong-Daok Moon, Daejeon (KR)

(73) Assignee: Electronics and Telecommunications Research Institute, Daejeon (KR)

(21) Appl. No.: 12/967,635

(22) Filed: Dec. 14, 2010

(30) Foreign Application Priority Data
Dec. 18, 2009 (KR) 10-2009-0126721
Apr. 12, 2010 (KR) 10-2010-0033393

(51) Int. Cl. G06F 17/30

(52) U.S. Cl. 707/756; 707/E17.044

(57) ABSTRACT

A data mapping device according to an exemplary embodiment of the present invention includes a system-information collecting unit configured to collect information on any one or more of a transmission device and a reception device connected through a network, a rule extracting unit configured to extract a data mapping rule corresponding to the information from a mapping-rule DB, and a data mapping unit configured to perform a mapping of data input from the transmission device according to the data mapping rule and to transmit the data to the reception device. According to the present invention, it is possible to improve interoperability between devices connected through a network.

### RELATED APPLICATIONS

The present application claims priority to Korean Patent Application Number 10-2009-0126721, filed on Dec. 18, 2009, and 10-2010-0033393, filed on Apr. 12, 2010, the entirety of which is hereby incorporated by reference.

### BACKGROUND OF THE INVENTION

1. Field of the Invention

The present invention relates to a device and method for performing a mapping of data of a network device.

2. Description of the Related Art

Internet capable devices ranging from a PDA and a portable phone to a watch in addition to a personal computer (PC) are increasing day by day. Individual devices have their own unique attributes such as operating systems, display sizes, and different input/output devices. Further, individual devices have unique user interfaces.

For example, some devices use keyboards and mouses as input devices, some devices use touch screens as input devices, and some devices receive user commands by voice.

As such, data information transmitted and received between various devices is transmitted to a reception device regardless of the function and performance of the reception device. Therefore, when a transmission device transmits data information to a reception device, a method capable of performing a mapping of data in consideration of the performance and function of the reception device and transmitting is required. Meanwhile, ‘APPARATUS OF TRANSFORMING MULTIMEDIA SERVICE FORMAT, SYSTEM OF PROVIDING MULTIMEDIA SERVICE’ is disclosed in Korea Patent Laid Open Publication No. 10-2009-0001687. In this published patent, there are provided an apparatus for transforming a multimedia service format which extracts corresponding event information per service by analyzing multimedia service packets (for example, TPEG service packets, etc.) and transforms a multimedia service format into an XML (extensible markup language) file according to a text format of the XML file, thereby making multimedia service supply through an Internet browser easy, and a multimedia service providing system using the same.

However, the above-mentioned related art suggests only a format for processing multimedia data and a transforming method for analyzing multimedia service packets but does not specifically consider a method of performing a mapping of data information from a transmission device according to the function and performance of a reception device to be appropriate for the reception device and transmitting it to the reception device.

### SUMMARY OF THE INVENTION

The present invention has been made in an effort to provide a device and method for performing a mapping of data of a network device which make it possible to provide an effective data process function by generating appropriate information in a reception device receiving and processing data transferred from a transmission device.

An exemplary embodiment of the present invention provides a data mapping device including: a system-information collecting unit configured to collect information on any one or more of a transmission device and a reception device connected through a network; a rule extracting unit configured to extract a data mapping rule corresponding to the information from a mapping-rule DB; and a data mapping unit configured to perform a mapping of data input from the transmission device according to the data mapping rule and to transmit the data to the reception device.

In particular, the system-information collecting unit may collect the information by analyzing a data specification of data transmitted and received between the transmission device and the reception device.

Further, the data mapping device may further include a rule editing unit configured to edit the data mapping rule registered in the mapping-rule DB according to a user's request.

The data mapping unit may perform a mapping of the input data into a format that can be processed in the reception device according to the data mapping rule.

The rule extracting unit may extract the data mapping rule from the mapping-rule DB by using device information on performances and functions of any one or more of the transmission device and the reception device included in the collected information.

When the transmission device and the reception device belong to the same device group performing the same function, the data mapping unit may perform data mapping by analyzing a tag applied to the data mapping rule differently.

The data mapping unit may perform a structure mapping and semantic mapping of the input data.

Another exemplary embodiment of the present invention provides a data mapping method including: collecting information on any one or more of a transmission device and a reception device connected through a network; extracting a data mapping rule corresponding to the collected information from a mapping-rule DB; and performing a mapping of data input from the transmission device according to the data mapping rule and transmitting the data to the reception device.

Further, in the collecting of the information on any one or more of the transmission device and the reception device, the information may be collected by analyzing a data specification of data transmitted and received between the transmission device and the reception device.

The data mapping method may further include editing the data mapping rule registered in the mapping-rule DB according to a user's request.

When the transmission device and the reception device belong to the same device group performing the same function, in the performing of the mapping of data input from the transmission device, data mapping may be performed by analyzing a tag applied to the data mapping rule differently.

In the performing of the mapping of data input from the transmission device, a mapping of the input data into a format that can be processed in the reception device according to the extracted data mapping rule is performed.

The information on any one or more of the transmission device and the reception device may be device information on performances and functions of any one or more of the transmission device and the reception device.

According to the embodiments of the present invention, the following effects can be expected.

First, it is possible to improve interoperability between devices connected through a network.

Second, the exemplary embodiments of the present invention can be applied to applications of a data process field among a network device, a UI device, and a home network device.

Third, since a mapping of data transmitted from a transmission device connected through a network is performed appropriately for a function of a reception device and then the data is provided, the reception device can receive the corresponding data and perform effective control and operation.

### BRIEF DESCRIPTION OF THE DRAWINGS

FIG. 1 is a block diagram illustrating the concept of a data mapping system according to an exemplary embodiment of the present invention;

FIG. 2 is a block diagram for explaining a configuration of the data mapping device shown in FIG. 1;

FIG. 3 is a drawing illustrating an example of a data mapping rule stored in a DB shown in FIG. 2;

FIG. 4 is a drawing illustrating an example of the data specification 5a shown in FIG. 2;

FIG. 5 is a drawing illustrating a result obtained by performing a mapping of the data specification of FIG. 4 according to the data mapping rule of FIG. 3;

FIG. 6 is a drawing for explaining data mapping rules for data mapping;

FIG. 7 is a drawing illustrating a result obtained by data mapping in a data mapping device according to an exemplary embodiment of the present invention; and

FIG. 8 is a flow chart for explaining a data mapping method according to an exemplary embodiment of the present invention.

### DESCRIPTION OF THE PREFERRED EMBODIMENTS

Exemplary embodiments of the present invention will now be described in detail with reference to the accompanying drawings. Here, a repeated description and a detail description of well-known functions and configurations capable of unnecessarily obscuring the subject matter of the present invention will be omitted. Embodiments of the present invention are provided in order to more completely explain the present invention to those having average knowledge in this art. Therefore, the shapes and sizes of elements in the drawings may be exaggerated for clearer explanation.

Hereinafter, embodiments of the present invention will be described with reference to the accompanying drawings.

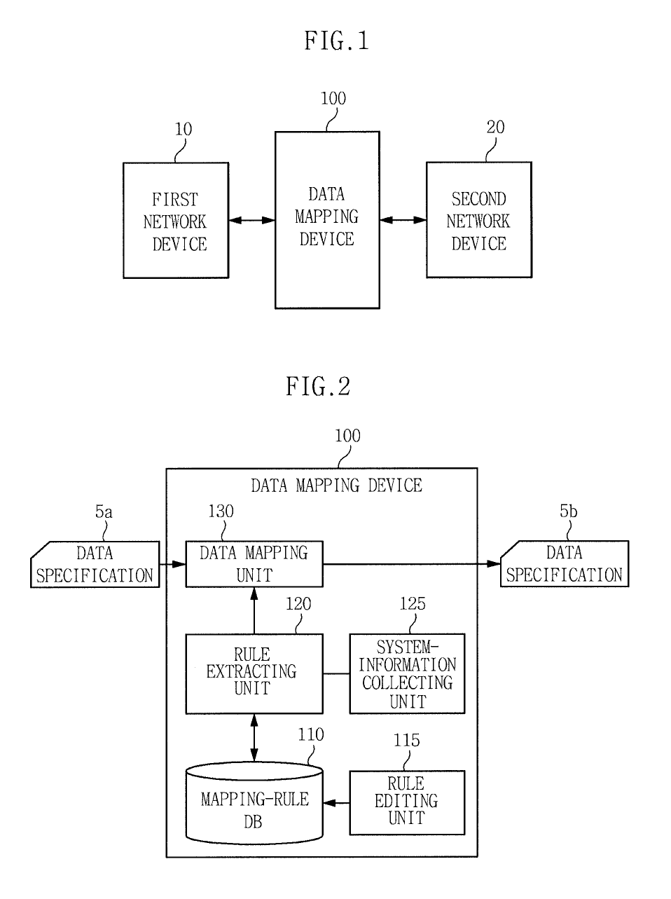

FIG. 1 is a block diagram illustrating the concept of a data mapping system according to an exemplary embodiment of the present invention.

Referring to FIG. 1, a data mapping device 100 performs a mapping of data received from any one network device between two devices 10 and 20 connected through a network and transmits the data to the other network device.

That is, if receiving data from a first network device 10, the data mapping device 100 according to the exemplary embodiment of the present invention collects system information of the data mapping system including information on the first network device 10 and a second network device 20, performs a mapping of the data received from the first network device 10 on the basis of the collected information, and transmits the data to the second network device 20. In this case, the transmitted data may be, for example, data for controlling the operation of the second network device 20.

Similarly, if receiving data from the second network device 20, the data mapping device 100 collects system information of the data mapping system, performs a mapping of the data received from the second network device 20 on the basis of the collected information, and transmits the data to the first network device 10.

In performing a mapping of received data, the data mapping device 100 according to the exemplary embodiment of the present invention performs a mapping of data by applying a data mapping rule corresponding to collected system information, thereby performing a mapping of the data in consideration of the performance and function of a reception device.

Meanwhile, the mapping function of the data mapping device 100 according to the exemplary embodiment of the present invention may be configured in a transmission device, a reception device, or both of the transmission device and the reception device or may be configured separately from the transmission device and the reception device as shown in FIG. 1.

FIG. 2 is a block diagram for explaining a configuration of the data mapping device shown in FIG. 1.

Referring to FIG. 2, the data mapping device 100 includes a mapping-rule DB 110, a rule editing unit 115, a rule extracting unit 120, a system-information collecting unit 125, and a data mapping unit 130.

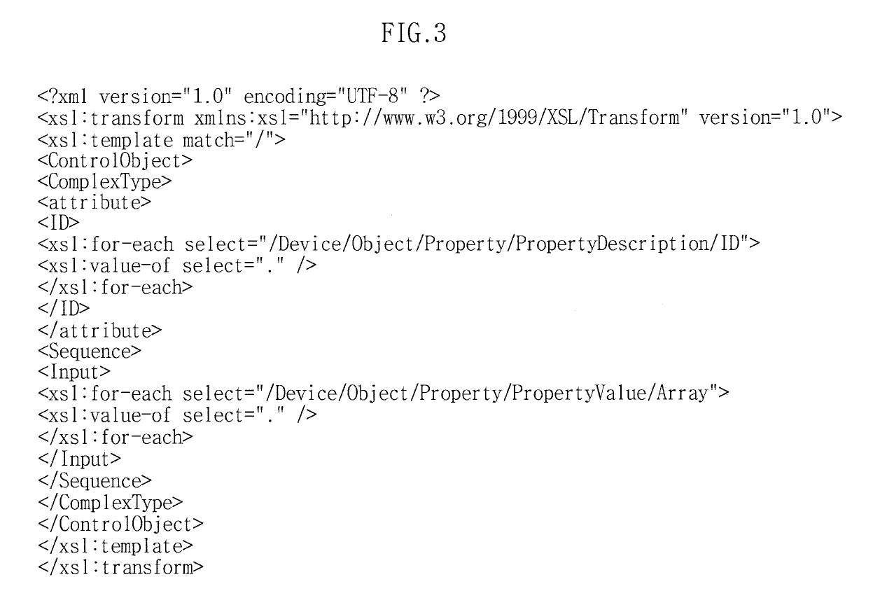

The mapping-rule DB 110 stores individual data mapping rules corresponding to system information including device information on transmission devices transmitting data and the performance and function of reception devices receiving the data. For example, the mapping-rule DB 110 stores various mapping rules corresponding to each performance and function of a reception device and provides a corresponding data mapping rule to the rule extracting unit 120 in response of a request of the rule extracting unit 120. FIG. 3 is a drawing illustrating an example of a data mapping rule stored in the mapping-rule DB 110. The data mapping rules specify rules for performing a mapping of individual sections of source data onto individual sections of data after mapping.

The rule editing unit 115 provides a function making it possible to edit the data mapping rules registered in the mapping-rule DB 110 according to a user's request. The data mapping rules registered in the mapping-rule DB 110 may be edited by a user according to a variation in the performance and function of a corresponding reception device or transmission device.

The rule extracting unit 120 receives system information of the data mapping system from the system-information collecting unit 125, extracts a data mapping rule corresponding to the received system information from the mapping-rule DB 110, and transmits the data mapping rule to the data mapping unit 130.

The system-information collecting unit 125 collects device information on the performances and functions of devices connected to each other through a network, and transmits the collected information to the rule extracting unit 120. In order to collect the system information, the system-information collecting unit 125 analyzes a data specification of data transmitted by a transmission device and received by a reception device to collect the system information.

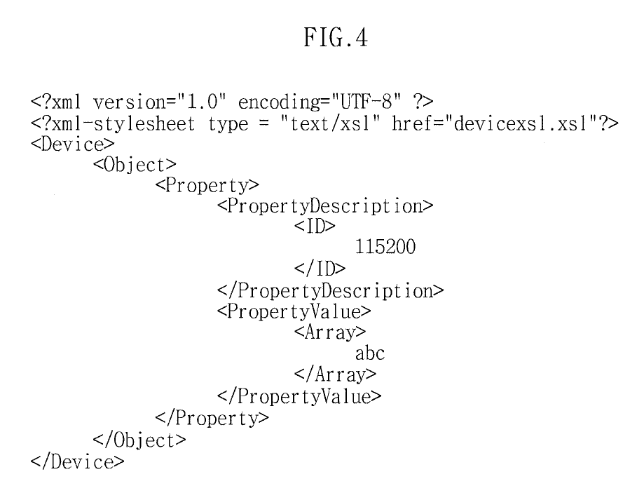

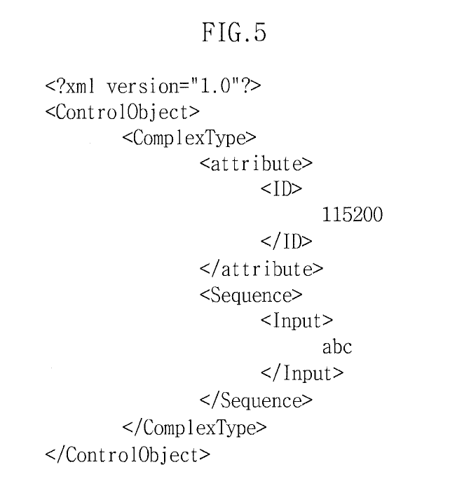

If receiving a data specification 5a from the transmission device, the data mapping unit 130 performs a mapping of the received data specification 5a by using the data mapping rule received from the rule extracting unit 120. Then, if mapping is completed, the data mapping unit 130 transmits the data specification 5b after mapping to the reception device. FIG. 4 is a drawing illustrating an example of the data specification 5a, and FIG. 5 is a drawing illustrating a result obtained by performing a mapping of the data specification 5a according to the data mapping rule of FIG. 3.

That is, the data mapping unit 130 performs a mapping of the data received from the transmission device according to the data mapping rule extracted from the mapping-rule DB 110 to enable the reception device to process the corresponding data. In this case, when the transmission device and the reception device belong to the same device group performing the same function, the data mapping unit 130 analyzes a tag applied to the data mapping rule differently and performs data mapping.

The data mapping in the data mapping unit 130 includes structure mapping and semantic mapping as shown in FIGS. 3 to 5.

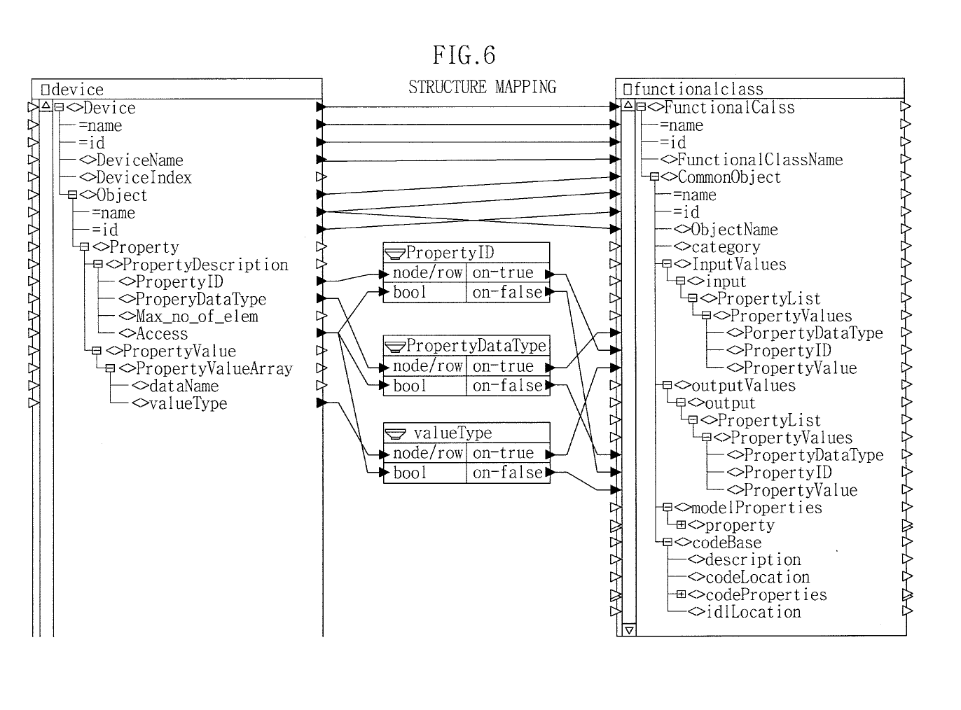

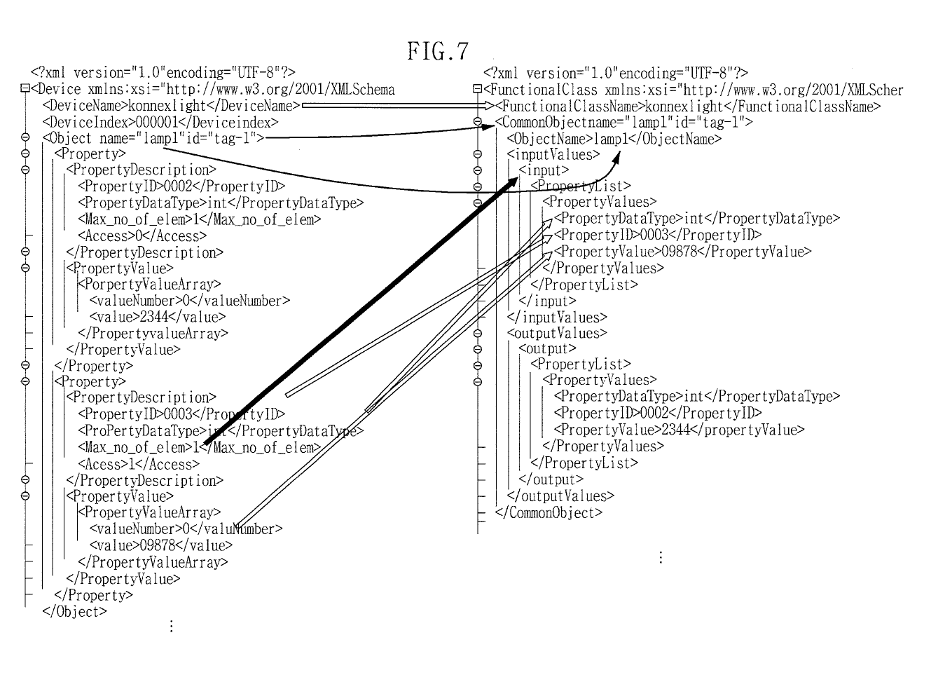

FIG. 6 is a drawing for explaining data mapping rules for data mapping.

The data mapping rules applied to the embodiment of the present invention, that is, stored in the mapping-rule DB 110 specify rules for performing a mapping of individual sections of data (source data) received from the transmission device onto individual sections of data (data after mapping) to be transmitted to the reception device. FIG. 7 is a drawing illustrating a result obtained by data mapping in a data mapping device according to an exemplary embodiment of the present invention.

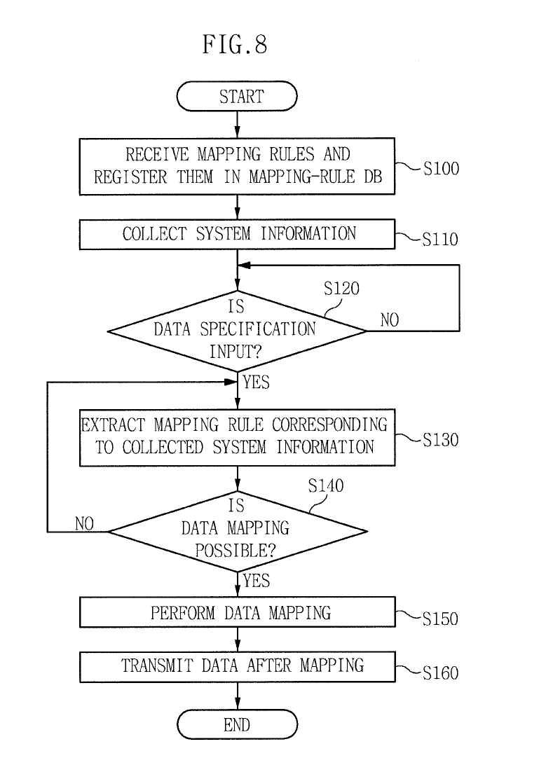

FIG. 8 is a flow chart for explaining a data mapping method according to an exemplary embodiment of the present invention.

Referring to FIG. 8, first, the data mapping device receives data mapping rules from a user and registers them in the mapping-rule DB (S100). It is apparent that the data mapping rules registered in the mapping-rule DB may be edited by the user according to a variation in the performance and functions of the transmission device and the reception device.

Next, if it is confirmed that two devices (the transmission device and the reception device) are connected through the network, specification of data transmitted between two devices is analyzed, and information on the individual devices is collected (S110).

If information on two devices connected to each other is collected through Step S110, it is checked whether data is received from the transmission device (S120).

If data is received through Step S120, a data mapping rule corresponding to the information collected through Step S110 is extracted (S130), and it is determined whether it is possible to perform a mapping of the data received from the transmission device by using the extracted data mapping rule (S140).

As a result of the determination in Step S140, if it is possible to perform a mapping of data by using the extracted data mapping rule, a mapping of the corresponding data is performed (S150). In this case, when the transmission device and the reception device belong to the same device group performing the same function, a tag applied to the data mapping rule is analyzed differently and performs data mapping.

According to the exemplary embodiments of the present invention, it is possible to improve interoperability between devices connected through a network. Further, since a mapping of data transmitted from a transmission device connected through a network is performed appropriately for a function of a reception device and then the data is provided, the reception device can receive the corresponding data and perform effective control and operation.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. A data mapping device comprising:
a system-information collecting unit configured to collect information on any one or more of a transmission device and a reception device connected through a network;
a rule extracting unit configured to extract a data mapping rule corresponding to the information from a mapping-rule DB; and
a data mapping unit configured to perform a mapping of data input from the transmission device according to the data mapping rule and to transmit the data to the reception device.

2. The data mapping device according to claim 1, wherein:
the system-information collecting unit collects the information by analyzing a data specification of data transmitted and received between the transmission device and the reception device.

3. The data mapping device according to claim 1, further comprising:
a rule editing unit configured to edit the data mapping rule registered in the mapping-rule DB according to a user's request.

4. The data mapping device according to claim 1, wherein:
the data mapping unit performs a mapping of the input data into a format that can be processed in the reception device according to the data mapping rule.

5. The data mapping device according to claim 1, wherein:
the rule extracting unit extracts the data mapping rule from the mapping-rule DB by using device information on performances and functions of any one or more of the transmission device and the reception device included in the collected information.

6. The data mapping device according to claim 1, wherein:
when the transmission device and the reception device belong to the same device group performing the same function, the data mapping unit performs data mapping by analyzing a tag applied to the data mapping rule differently.

7. The data mapping device according to claim 1, wherein:
the data mapping unit performs a structure mapping and semantic mapping of the input data.

8. A data mapping method comprising:
collecting information on any one or more of a transmission device and a reception device connected through a network;
extracting a data mapping rule corresponding to the collected information from a mapping-rule DB; and
performing a mapping of data input from the transmission device according to the data mapping rule and transmitting the data to the reception device.

9. The data mapping method according to claim 8, wherein:
in the collecting of the information on any one or more of the transmission device and the reception device, the information is collected by analyzing a data specification of data transmitted and received between the transmission device and the reception device.

10. The data mapping method according to claim 8, further comprising:
editing the data mapping rule registered in the mapping-rule DB according to a user's request.

11. The data mapping method according to claim 8, wherein:
when the transmission device and the reception device belong to the same device group performing the same function, in the performing of the mapping of data input from the transmission device, data mapping is performed by analyzing a tag applied to the data mapping rule differently.

12. The data mapping method according to claim 8, wherein:
in the performing of the mapping of data input from the transmission device, a mapping of the input data into a format that can be processed in the reception device according to the extracted data mapping rule is performed.

13. The data mapping method according to claim 8, wherein:
the information on any one or more of the transmission device and the reception device is device information on performances and functions of any one or more of the transmission device and the reception device.
